(19) United States
(12) Patent Application Publication
(10) Pub. No.: US 2017/0327054 A1
(43) Pub. Date: Nov. 16, 2017

(54) MULTIFUNCTIONAL STAND FOR COMMUNICATION TERMINAL

(71) Applicant: ELIM CO., LTD., Gyeonggi-do (KR)

(72) Inventors: Young Rok YU, Gyeonggi-do (KR); Jae Hoon SHIN, Gyeonggi-do (KR)

(73) Assignee: ELIM CO., LTD., Gyeonggi-do (KR)

(21) Appl. No.: 15/529,931

(22) PCT Filed: Nov. 28, 2014
(86) PCT No.: PCT/KR2014/011529

§ 371 Date: May 25, 2017

(51) Int. Cl. B60R 11/02; H04M 1/06; H04M 1/60; G06F 1/16

(52) U.S. Cl. CPC B60R 11/0241; H04M 1/6091; H04M 1/06; G06F 1/16

(57) ABSTRACT

A multifunctional stand for a communication terminal comprises: a front case (110); a rear case (120); a swing hinge (130) having one side fastened to the front case (110); a rotating body (140) which rotates by being fastened to the other side of the swing hinge (130); a supporter (151), provided on the rotating body (140), for supporting a communication terminal (10); a pair of holders (161, 162), provided on the rotating body (140), for holding the communication terminal (10); and a speaker box (198), provided on the rear surface of the rear case (120), for standing the stand (100) on an object on which the stand will be disposed, wherein the pair of holders (161, 162) hold the communication terminal (10) by controlling the distance between the holders (161, 162) by moving according to the width (w1) of the communication terminal (10).

### BACKGROUND

The present invention relates to a multi-functional stand for a communication terminal and, more particularly, to a multi-functional stand for a communication terminal, which has been adapted to hold a communication terminal easily and conveniently regardless of the size of the communication terminal in a non-electric motion manner and to release a held communication terminal rapidly and conveniently in a non-electric motion manner.

With the recent development of a communication technology and multimedia technology, mobile functions having different environments, such as an image and music, rather than a simple communication technology, are collaborated into a communication terminal, and thus various applications are used in one terminal.

Today, roles, such as the Internet, life information and a messenger, and functions, such as navigation, moving images, music and photos, on the basis of a call are grafted onto a wireless communication technology to implement a more human-oriented function.

A conventional technology had a problem in that there is a burden on space utilization and the price because a Bluetooth speaker, a stand for a vehicle and a hands-free function were separately configured.

Furthermore, a conventional stand for a communication terminal can be held only in any one of a vertical direction and a horizontal direction. Accordingly, if the conventional stand for a communication terminal is held in the vertical direction for a call purpose, it is inconvenient to watch an application for basic horizontal watching, such as a moving image or TV.

Furthermore, the conventional stand for a communication terminal had a lot of inconvenience in an operation for holding the side of a communication terminal and an operation for releasing a held terminal.

Prior Art Document 1: Korean Patent No. 10-1020434 (issued on Mar. 9, 2011)

Prior Art Document 2: Korean Patent Application Publication

No. 10-2013-0115313 (laid open on Oct. 21, 2013).

### SUMMARY OF THE INVENTION

The present invention has been invented to solve the problems of the conventional technology, and an object of a multi-functional stand for a communication terminal according to the present invention is to provide a multi-functional stand for a communication terminal which is adapted to:

first, stand a communication terminal regardless of the size of the communication terminal,

second, firmly hold a communication terminal through a simple configuration,

third, allow a pair of holders to fasten or widen a communication terminal at the same time in such a manner that when one of the pair of holder moves, the other holder also moves at the same time and thus allow the holding operation and holding release operation of the communication terminal by the holders to be performed rapidly and conveniently,

fourth, release a held communication terminal rapidly and simply in a non-electric motion manner in such a way as to release the held communication terminal by outward widening the holders that hold the communication terminal by a simple operation of pressing a release button and thus provide a user with convenience in holding and release,

fifth, closely attach and hold a communication terminal at the front of a rotating unit regardless of the thickness of the communication terminal by a simple action to backward push the communication terminal inserted into a charging terminal,

sixth, mount a joint on a rear case easily and conveniently even in a narrow space,

seventh, charge the battery of a communication terminal when the communication terminal is held in the stand and output voice and output audio signals output when an application, such as an image or music, is executed through a speaker box other than the communication terminal,

eighth, improve space utilization of the place where the stand will be held (e.g., within a vehicle) by integrating and implementing functions, such as Bluetooth, an external speaker and a charger, into a single holding device, and

ninth, hold a communication terminal at a required location in a horizontal direction or a vertical direction.

### Technical Solution

A multi-functional stand for a communication terminal according to the present invention for achieving the above object includes a front case; a rear case coupled to the front case; a swing hinge comprising a fixing part and a rotational part rotating forward or backward at an angle set in the fixing part, wherein the fixing part is fixed to the front case; a rotating unit fixed to the rotational part of the swing hinge and rotating in response to the rotation of the rotational part; a support protruded on the lower side of the front surface of the rotating unit and rotated along with the rotating unit, wherein the support supports a communication terminal; a pair of holders upward spaced apart the support and provided in a front surface of the rotating unit, wherein the pair of holders rotates along with the rotating unit and holds the communication terminal supported by the support; a speaker box coupled to a rear surface of the rear case, supporting the front case and the rear case so that an object on which the stand is to be disposed is upright, and outputting an audio signal output by the communication terminal, wherein the pair of holders moves inward or outward along the width of the communication terminal and holds the communication terminal by adjusting a distance between the pair of holders.

### Advantageous Effects

The multi-functional stand for a communication terminal according to the present invention having the above configuration has the following effects.

First, a communication terminal can be held regardless of the size of the communication terminal.

Second, a communication terminal can be firmly held through a simple configuration including a first elastic member and holder stop means.

Third, when one of the pair of holder moves, the other holder also moves at the same time, and thus the holding operation and holding release operation of a communication terminal can be performed rapidly and conveniently.

Fourth, the holding of a communication terminal can be released rapidly and simply in a non-electric motion manner by a simple operation of pressing a release button.

Fifth, a communication terminal can be closely attached and held at the front of the rotating unit regardless of the thickness of the communication terminal by a simple action to backward push the communication terminal inserted into a charging terminal. Accordingly, the holding of the communication terminal can be further stabilized.

Sixth, a joint can be mounted on the rear case easily and conveniently even in a narrow space.

Seventh, the battery of a communication terminal can be charged when the communication terminal is held in the stand, and voice and audio signals output when an application, such as an image or music, is executed can be output through the speaker box other than the communication terminal.

Eighth, space utilization of the place where the stand will be held (e.g., within a vehicle) can be improved by integrating and implementing functions, such as Bluetooth, an external speaker and a charger, into a single holding device.

Ninth, a communication terminal can be held at a required location in a horizontal direction or a vertical direction.

### BRIEF DESCRIPTION OF DRAWINGS

FIG. 1 is a perspective view of a multi-functional stand for a communication terminal according to an embodiment of the present invention and an exemplary diagram showing the state in which the multi-functional stand is used.

FIG. 2 is a rear view of the multi-functional stand for a communication terminal according to an embodiment of the present invention.

FIG. 3 is an exploded perspective view showing major elements of the multi-functional stand for a communication terminal according to an embodiment of the present invention.

FIG. 4 is an exploded perspective view of a front case 110 and a rotating unit 140 in FIG. 3.

FIG. 5 is a rear-perspective view of the state in which a swing hinge 130 has been mounted on a rotating unit body 140′ in FIG. 4.

FIG. 6 is an exploded perspective view of major elements mounted on a rotating unit cover 140″ in FIG. 4.

FIG. 7 is a rear perspective view of the rotating unit cover 140″ in FIG. 4.

FIG. 8 is a cutaway rear view illustrating part of the inside of the figure disclosed in FIG. 7.

FIG. 9 is a diagram for illustrating a connection relation between holders 161 and 162 and a guide member 171 in FIG. 6.

FIG. 10 is a diagram for illustrating an operation relation between a release button 167 and a stopper 165 in FIG. 6.

FIG. 11 is an exploded perspective view showing the state in which a joint 180 has been separated in FIG. 2 and is a front view of the joint.

FIG. 12 is a front perspective view of a rear case 120 showing the state in which the rear case has been mounted on a speaker box 198 in FIG. 3.

FIG. 13 is an exploded perspective view of the rear case 120 and the speaker box 198.

FIG. 14 is an operational diagram of the state in which the rotating unit 140 has been counterclockwise turned 90° and a communication terminal 10 has been horizontally held in the state in which the communication terminal 10 has been supported by the support 151 and held by holders 161 and 162 in FIG. 1.

FIG. 15 is an operational diagram of the state in which the holders 161 and 162 have inward moved in the state of FIG. 1.

FIG. 16 is a side view of the state in which the communication terminal 10 having a thin thickness has been held.

FIG. 17 is an operational diagram showing that the communication terminal 10 is pushed and closely attached to a nonslip member R1.

FIG. 18 is a cross-sectional view of major elements for illustrating the state in which a terminal rotation shaft 193 has been installed in the multi-functional stand for a communication terminal according to an embodiment of the present invention.

### DETAILED DESCRIPTION OF THE INVENTION

Hereinafter, a preferred embodiment of a multi-functional stand for a communication terminal according to the present invention is described in detail with reference to the accompanying drawings.

In this specification, “forward” is the direction in which a held communication terminal 10 is oriented, and “backward” is a direction opposite the forward. “Inward” is the direction in which a pair of holders 161 and 162 gathers at the center of a rotating unit 140, that is, the direction headed for the center of the rotating unit 140. “Outward” is the direction in which the pair of holders 161 and 162 becomes distant from each other.

As shown, a multi-functional stand 100 for a communication terminal according to an embodiment of the present invention is configured to include a front case 110, a rear case 120 coupled to the front case 110, a swing hinge 130, the rotating unit 140, a support 151, the pair of holders 161 and 162 and a speaker box 198.

A plurality of parts including a PCB M1 on which various circuit elements are to be mounted is provided in the space formed by the coupling of the front case 110 and the rear case 120.

A shaft hole 111 has been backward inserted at the center of the front case 110.

A bottom part 110a in which the rotating unit 140 of a disk form is to be seated and a circumference part 110b formed concentrically with the shaft hole 111 have been formed in the front case 110.

The swing hinge 130 includes a fixing part 131 and a rotational part 132 that rotates forward (counterclockwise) or backward (clockwise) at an angle set in the fixing part 131. The fixing part 131 has been fixed to the front case 110, and the rotational part 132 has been fixed to the rotating unit 140.

The swing hinge 130 operates semi-automatically. When a user turns the swing hinge at a critical angle (e.g., 45°) or more by his or her hand, a force is applied to the rotational part 132 by the action of a cam embedded in the swing hinge when the critical angle is exceeded, and thus the swing hinge is forward turned 90°.

The rotating unit 140 is fixed to the rotational part 132 of the swing hinge 130 and rotates in response to the rotation of the rotational part 132.

A shaft projection 141 has been backward protruded and formed in the rear surface 140b of the rotating unit 140 in such a way as to be rotatably inserted into the shaft hole 111. The rotating unit 140 has a disk form formed concentrically with the shaft projection 141.

The rotating unit 140 includes a rotating unit body 140′ and a rotating unit cover 140″ covering the rotating unit body 140′. In this case, the rear surface 140b of the rotating unit body 140′ becomes the rear surface 140b of the rotating unit, and the front surface 140a of the rotating unit cover 140″ becomes the front surface 140a of the rotating unit 140.

Furthermore, a pair of openings 143 formed to penetrate the rotating unit cover 140″ forward and backward has been formed in the rotating unit cover 140″.

A nonslip member R1 has been formed in the front surface 140a of the rotating unit 140, thus preventing the communication terminal 10 from sliding. The nonslip member R1 may be implemented using a material, such as rubber or soft synthetic resin, for example.

The support 151 has been forward protruded and formed on the lower side of the front surface 140a of the rotating unit 140, and rotates along with the rotating unit 140 while supporting the communication terminal 10.

The pair of holders 161 and 162 is upward spaced apart the support 151 and provided in the front surface 140a of the rotating unit 140. The pair of holders 161 and 162 rotates along with the rotating unit 140 and holds both sides of the communication terminal 10 supported by the support 151.

The pair of holders 161 and 162 moves inward or outward along the width w1 of the communication terminal 10 and holds the communication terminal 10.

The holders 161 and 162 include holder bodies 161a and 162a and handle parts 161b and 162b which are curved from the holder bodies 161a and 162a, which are exposed through the openings 143, and which apply an external force when the handle parts 161b and 162b are held by a user.

The speaker box 198 is coupled to the rear surface of the rear case 120. The speaker box 198 supports the front case 110 and the rear case 120 so that they are upright on an object on which the stand will be disposed (e.g., a dashboard for a vehicle), and outputs voice signal and an audio signal output by the communication terminal 10.

A fitting hole 198a has been formed on the front side of the speaker box 198. A fitting projection 123 has been backward protruded in the rear surface of the rear case 120, so the speaker box 198 is fitted into the rear case 120.

Accordingly, the speaker box 198 can be easily coupled to the rear case 120 or the coupling of the speaker box 198 can be easily released from the rear case 120.

The multi-functional stand 100 for a communication terminal according to an embodiment of the present invention is configured to further include a guide member 171.

The guide member 171 is disposed within the rotating unit 140, and includes an upper guide face 171a and a lower guide face 171a′ for guiding the pair of holders 161 and 162 so that the pair of holders 161 and 162 inward gathers or outward widens.

In order to mount the guide member 171 on the rotating unit cover 140″, an upper mounting unit 171c of a plate form has been upward curved from the upper guide face 171a and formed in the guide member 171 and a lower mounting unit 171c′ of a plate form has been downward curved from the lower guide face 171a′ and formed in the guide member 171.

Furthermore, gear exposure holes 171d have been formed in the upper mounting unit 171c and the lower mounting unit 171c′ so that first and second rack gears 163a and 163b and gears 173a, 173b and 173c are smoothly engaged even in a narrow space.

Furthermore, in accordance with an embodiment of the present invention, a pair of slide surfaces 161a′ and 161a″ and a pair of slide surfaces 162a′ and 162a″ have been curved toward the guide member 171 and formed on the upper and lower sides of the holder bodies 161a and 162a so that the holders 161 and 162 perform a linear motion while being guided by the upper guide face 171a and the lower guide face 171a′.

In the multi-functional stand 100 for a communication terminal according to an embodiment of the present invention, the guide member 171 is configured to further include first elastic members k1 and k2 and holder stop means 164, 165 and 166.

The first elastic member k1, k2 has one end elastically supported by an elastic support unit 161c, 162c formed in the holder 161, 162, and has the other end elastically supported by an elastic support piece 171b, 171b′ outward protruded from the upper and lower guide face 171a, 171a′ of the guide member 171. Accordingly, the first elastic member k1, k2 applies an outward elastic force to the holder 161, 162.

The holder stop means 164, 165 and 166 are elements which can inward move the holders 161 and 162 while compressing the first elastic members k1 and k2, but stop the outward movement of the holders 161 and 162 when an inward external force is applied to the holders 161 and 162 and stop the holders 161 and 162 at their positions when the external force applied to the holders 161 and 162 is removed.

The holder stop means 164, 165 and 166 include first sawteeth 164, a stopper 165 and a second elastic member 166.

The first sawteeth 164 are formed in a right-angled triangle pattern which has been inward inclined from the bottom of the slide surface 161a″ of one holder 161 of the pair of holders 161 and 162.

Meanwhile, the first sawteeth 164 are also formed in the other holder 162, but the same product can be produced and assembled regardless of the left and right.

The stopper 165 is disposed in the guide member 171 [more specifically, the lower mounting unit 171c′ of the guide member 171] so that the stopper performs a lever action using a shaft pin 165a as an axis. Second sawteeth 165b engaged with the first sawteeth 164 are formed on the other side of the stopper 165, and thus the stopper 165 stops the first sawteeth 164 so that it can move inward, but do not move outward.

Furthermore, a first incline 165c is formed on one side of the stopper 165.

The second elastic member 166 has a bottom elastically supported by an elastic support 166a formed in the rotating unit cover 140″ and has a top elastically supported by the other side of the stopper 165. Accordingly, the second elastic member 166 applies an elastic force to the other side of the stopper 165.

The multi-functional stand 100 for a communication terminal according to an embodiment of the present invention is configured to further include a release button 167 and a third elastic member 168.

A second incline 167a inclined at a tilt angle corresponding to the first incline 165c so that the second incline comes into surface contact with the first incline 165c has been formed in the release button 167. When a user presses the release button 167 in order to outward move the holders 161 and 162 by the elastic restoring force of the first elastic members k1 and k2, the release button 167 pushes one side of the stopper 165 upward and drops the other side of the stopper 165 downward by a lever action at the same time. Accordingly, the release button 167 releases locking (engagement) between the second sawteeth 165b and the first sawteeth 164.

When the release button 167 is pressed, locking is released and thus the holders 161 and 162 automatically widen outward by the elastic force of the first elastic members k1 and k2.

Furthermore, when the pressing of the release button 167 is released after the release button 167 is pressed, the release button 167 returns to its original position. At this time, the first and the second inclines 165c and 167a are closely attached.

The third elastic member 168 has one end elastically supported by the release button 167 and the other end elastically supported by the lower mounting unit 171c′ of the guide member 171 so that the release button 167 can return to its original position after the release button 167 is pressed.

The multi-functional stand 100 for a communication terminal according to an embodiment of the present invention is configured to further include interlocking means 163a, 163b, 173a, 173b and 173c.

When one holder 161 of the pair of holders 161 and 162 moves inward or outward, the interlocking means 163a, 163b, 173a, 173b and 173c move the other holder 162 in the same inward or outward direction while operating in conjunction with the one holder 161 so that the pair of holders 161 and 162 gathers or widens by driving the pair of holders 161 and 162 at the same time.

The interlocking means 163a, 163b, 173a, 173b and 173c include the first and the second rack gears 163a and 163b and the plurality of gears 173a, 173b and 173c.

The first and the second rack gears 163a and 163b are stepwise formed from the slide surfaces 161a″ and 162a′ in which the first sawteeth 164 of the holders 161 and 162 have been formed to the back and are formed toward the slide surfaces 161a′ and 162a″ that face the first and the second rack gears 163a and 163b.

The plurality of gears 173a, 173b and 173c is engaged with the first rack gear 163a formed in one holder 161 and the second rack gear 163b formed in the other holder 162. When the first rack gear 163a of one holder 161 moves inward or outward, the plurality of gears 173a, 173b and 173c moves the other holder 162 in the same direction as the first rack gear 163a so that the pair of holders 161 and 162 gathers or widens at the same time.

In accordance with the configuration, although any one of the pair of holders 161 and 162 is pushed or pulled, the pair of holders 161 and 162 operates inward or outward at the same time.

That is, although only one holder is pushed, the pair of holders 161 and 162 move inward at the same time. When the release button 167 is pressed, the pair of holders 161 and 162 widens symmetrically at the same time.

It is preferred that the gears 173a, 173b and 173c include a first pinion gear 173a, a driven gear 173c and a second pinion gear 173b. Accordingly, a motion direction can be changed by a simple configuration.

The first pinion gear 173a performs a rotary motion in response to a linear movement of the first rack gear 163a. The driven gear 173c rotates in the opposite direction in response to the rotation of the first pinion gear 173a. When the driven gear 173c rotates, the second pinion gear 173b rotates in the same direction as the first pinion gear 173a. When the second pinion gear 173b rotates, the second rack gear 163b linearly moves inward or outward linear like the first rack gear 163a.

In the multi-functional stand 100 for a communication terminal according to an embodiment of the present invention, a charging terminal 191 for supplying a charging current to the communication terminal 10 held in the support 151 has been protruded and provided in the support 151.

When the communication terminal 10 is connected to the charging terminal 191, the charging terminal 191 can supply a charging current to the communication terminal 10 through an external input terminal (not shown) connected to an external input port 195. Reference numeral 196 is a USB port 196 to which a USB jack 197 can be connected.

The multi-functional stand 100 for a communication terminal according to an embodiment of the present invention is configured to further include a locking hole 151b, a pair of bosses 152, a terminal housing 192 and a terminal rotation shaft 193.

The locking hole 151b is an element formed at the center of the top surface 151a of the support 151. The pair of bosses 152 is formed in the support 151 to face each other in a plate form.

A hollow part 192a has been formed within the terminal housing 192. Accordingly, the charging terminal 191 can be inserted into the hollow part 192a. A locking piece 192b locked and fixed to the locking hole 151b of the support 151 has been formed in the terminal housing 192.

In order to rotatably move the charging terminal 191 inserted into the terminal housing 192 forward or backward, the terminal rotation shaft 193 is laterally protruded from the outer circumferential surface of the terminal housing 192 and rotatably provided in the pair of bosses 152.

In accordance with the elements, the communication terminal 10 can be closely attached to the nonslip member R1 [accordingly, the front surface 140a of the rotating unit 140] regardless of the thickness of the communication terminal 10.

In the multi-functional stand 100 for a communication terminal according to an embodiment of the present invention, a mounting hole 121 has been formed in the rear surface of the rear case 120 and a plurality of locking hooks 122 has been formed in the inner circumferential surface of the mounting hole 121 at equal intervals.

Furthermore, the multi-functional stand 100 for a communication terminal according to an embodiment of the present invention is configured to further include a joint 180 in which locking stops 181 locked and fixed to the locking hooks 122 have been outward protruded in a radial direction in order to connect the multi-functional stand 100 for a communication terminal to an external instrument (not shown).

Accordingly, there is an advantage in that an attachment or detachment task can be easily performed even in a narrow space, such as a dashboard for a vehicle, because the joint 180 can be attached or detached from the stand 100 in a rotary manner according to the present invention.

The multi-functional stand 100 for a communication terminal according to an embodiment of the present invention is configured to further include guide rails 112 and a stop projection 142.

The guide rails 112 are elements spaced apart from the shaft hole 111 and inserted into the bottom part 110a of the front case 110 in an arc form concentric with the shaft hole 111.

A pair of the guide rails 112 has been illustrated in the figure, but this is for convenience of an assembly task. Only one guide rail is sufficient.

The stop projection 142 is an element which has been backward protruded from the rear surface 140b of the rotating unit 140 in such a way as to be inserted into the guide rail 112 and to rotate along the guide rail 112 and which prevents the rotating unit 140 from rotating at a set angle or more when the communication terminal 10 rotates (forward rotates) from a vertical direction to a horizontal direction or rotates backward.

Furthermore, a call button key (not shown) connected to a control board M1 and provided on one side of the rear case is further included. When a call button key is pressed, the control board M1 control the output of an audio signal so that a voice or an audio signal output by the communication terminal 10 is output through the speaker box 198 other than the speaker of the communication terminal 10 itself.

In the multi-functional stand 100 for a communication terminal according to an embodiment of the present invention, a volume switch (not shown) is provided on one side of the front case 110.

The operation of the multi-functional stand 100 for a communication terminal having the above configuration according to an embodiment of the present invention is described below.

An operation for holding the communication terminal 10 by the holders 161 and 162 is first described below.

At the beginning, the first sawteeth 164 and the second sawteeth 165b have been engaged and the second elastic member 166 applies an elastic force to the other side of the stopper 165. Accordingly, the holders 161 and 162 are stopped at their positions unless an external force is applied.

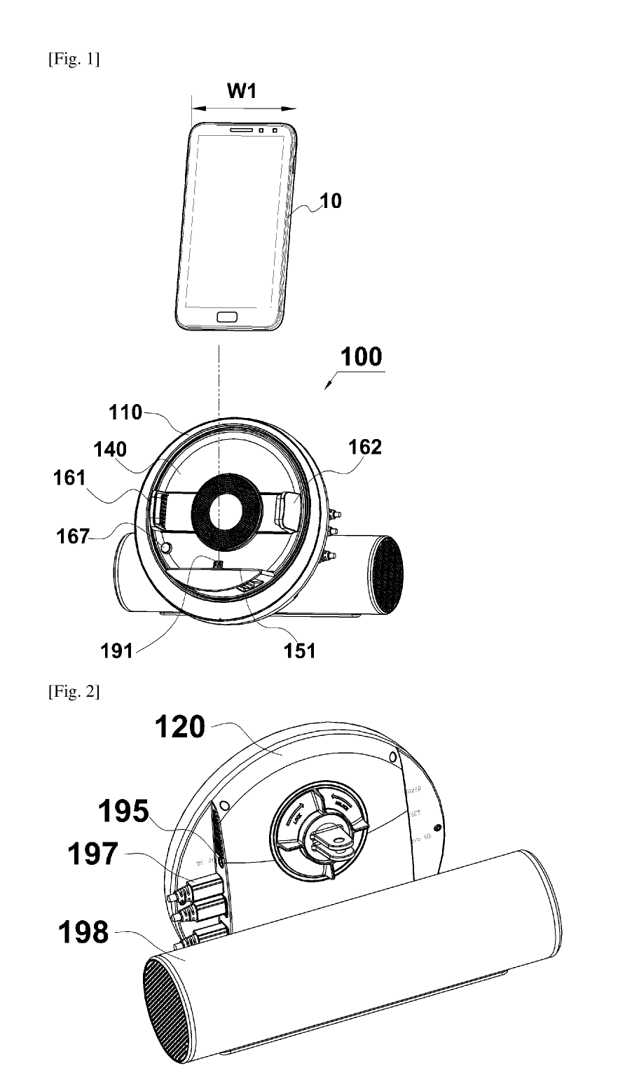

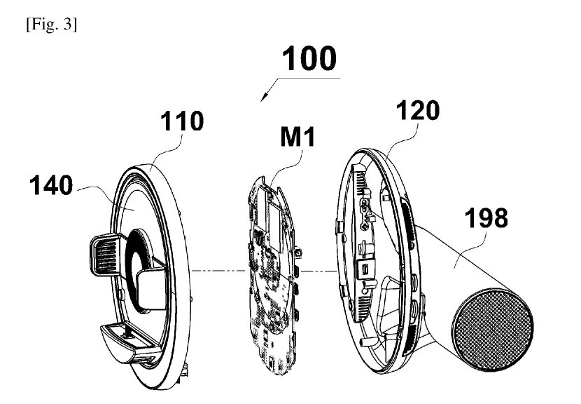

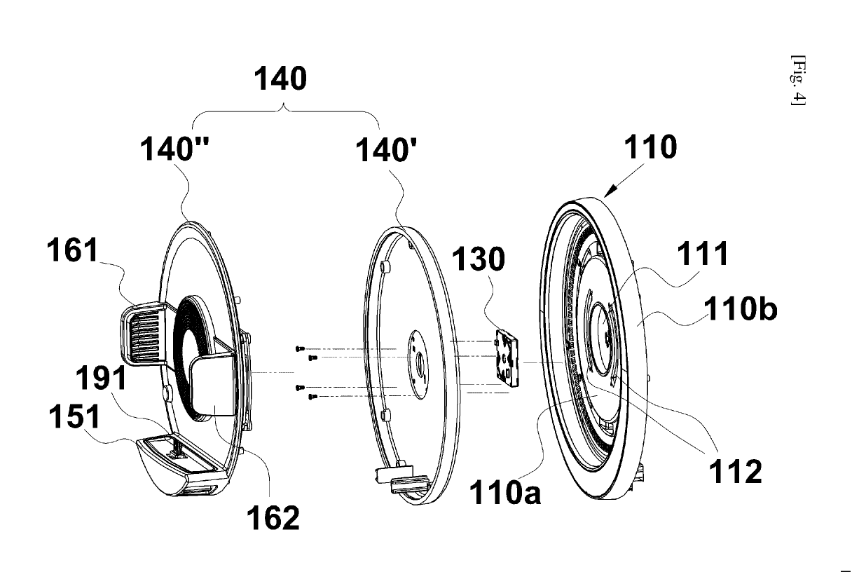

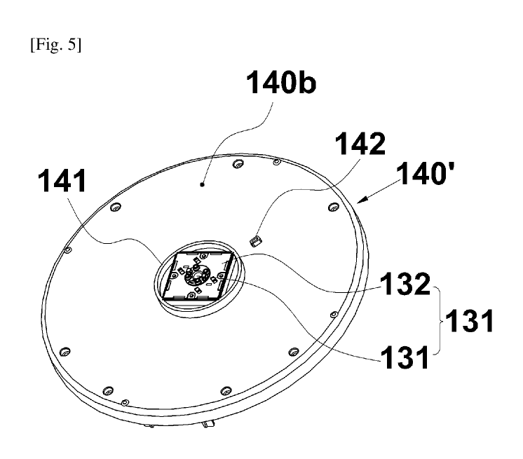

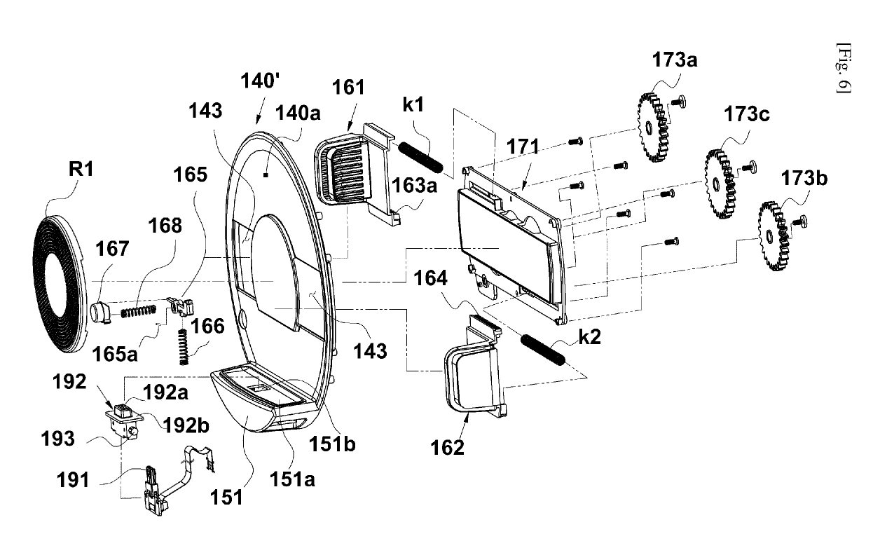

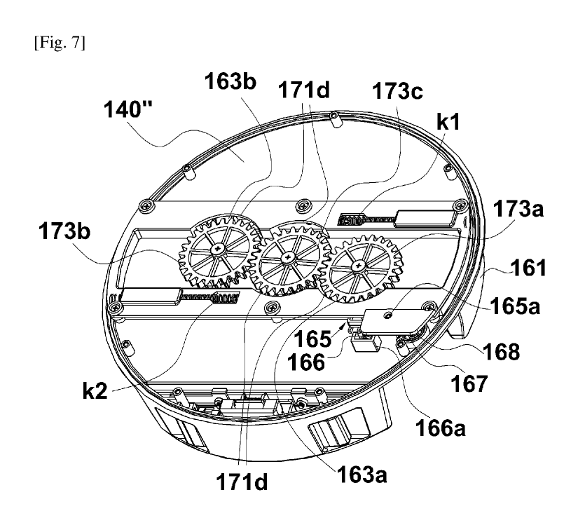

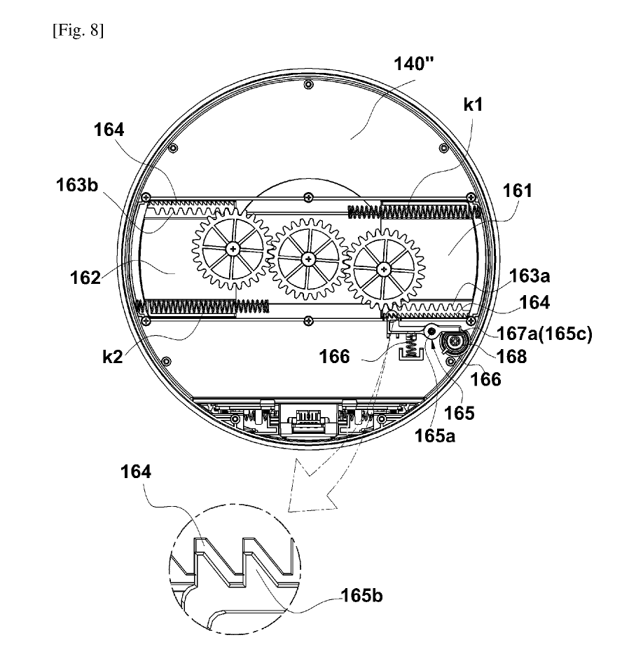

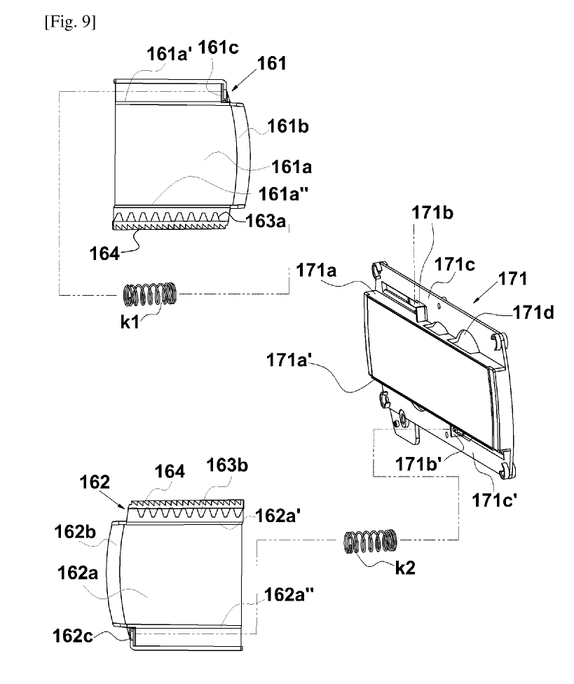

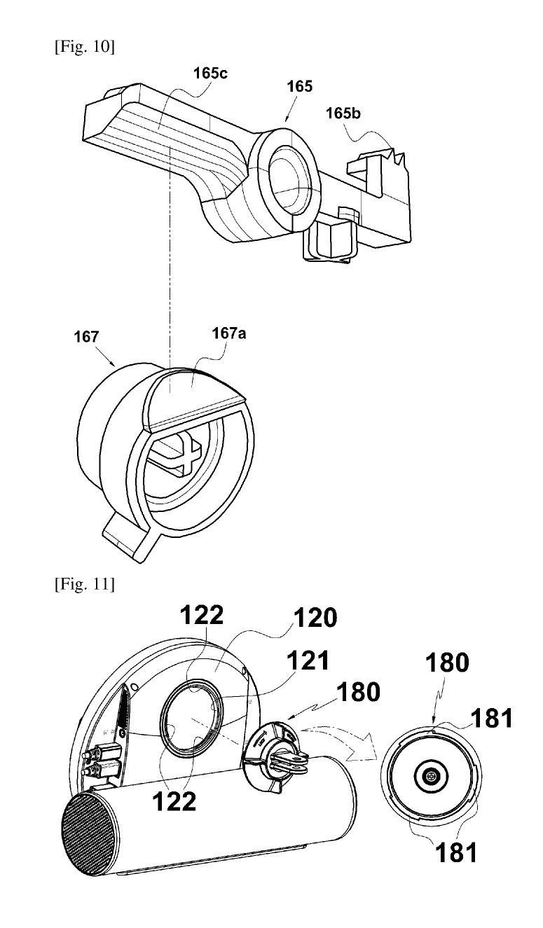

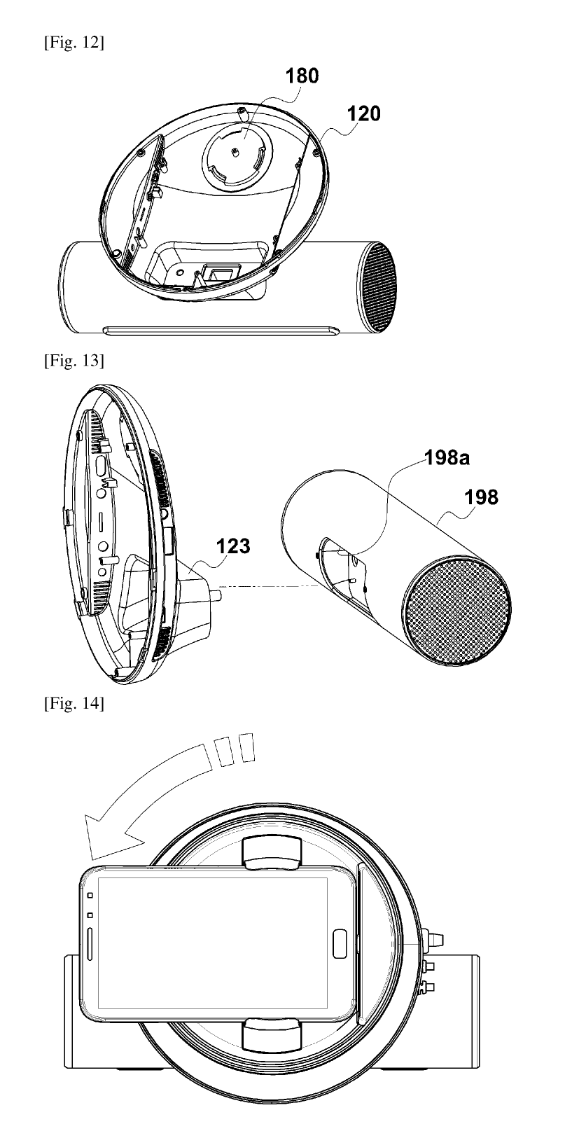

In the state disclosed in FIG. 1, when one holder 161 is inward pressed, the first sawteeth 164 climbs up the second sawteeth 165b of the stopper 165 along a diagonal line (the hypotenuse of a right-angled triangle pattern) and thus one holder 161 moves inward.

At this time, an operation of the first sawteeth 164 being engaged with the second sawteeth 165b after the first sawteeth 164 climbs up the second sawteeth 165b is repeated because the second elastic member 166 pushes the other side of the stopper 165. Accordingly, one holder 161 moves inward.

When one holder 161 is inward pushed as described above, the other holder 162 moves in the same inward direction while operating in conjunction with one holder 161, and thus the pair of holders 161 and 162 inward operates at the same time. Such a simultaneous operation is described below.

When one holder 161 is pushed, the first rack gear 163a moves inward and the first pinion gear 173a performs a rotary motion counterclockwise in response to the inward linear movement of the first rack gear 163a. When the first pinion gear 173a rotates, the driven gear 173c rotates clockwise. When the driven gear 173c rotates, the second pinion gear 173b rotates counterclockwise. When the second pinion gear 173b rotates, the second rack gear 163b performs a linear movement inward like the first rack gear 163a. The other holder 162 moves inward in response to the inward linear movement of the second rack gear 163b.

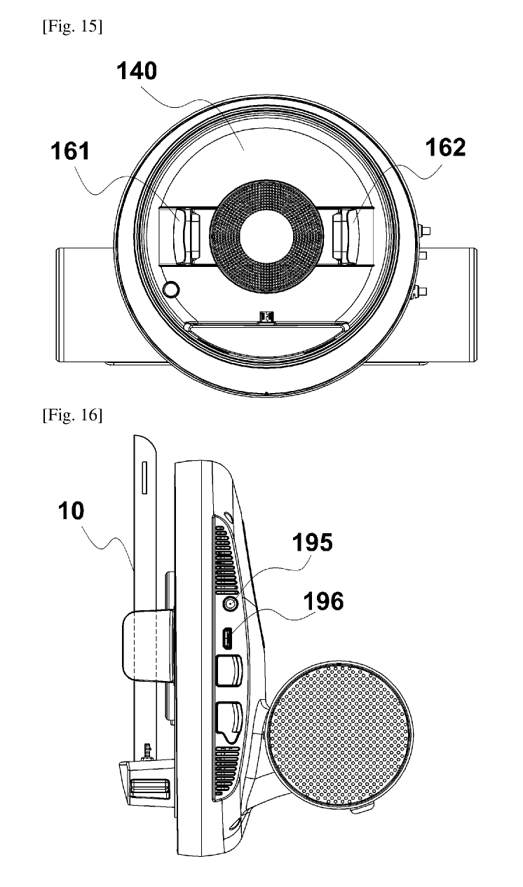

Accordingly, when one holder 161 is inward pushed, the other holder 162 also moves inward (refer to FIG. 15) according to the above operation relation. If the communication terminal 10 has been held in the stand, the pair of holders 161 and 162 strongly holds the held communication terminal 10 by fastening the held communication terminal 10.

An operation for releasing the holding of a communication terminal in order to separate the communication terminal from the stand after the communication terminal is held as described above is described below.

When the release button 167 is pressed, the second incline 167a pushes the first incline 165c upward. When the first incline 165c upward rises, one side of the stopper 165 including the first incline 165c upward rises. When one side of the stopper 165 upward rises, the other side of the stopper 165 descends downward by a lever action on the basis of the shaft pin 165a.

When the other side of the stopper 165 descends downward, the second sawteeth 165b is separated from the first sawteeth 164 and thus the engagement between the second sawteeth 165b and the first sawteeth 164 is released. When the locking of the second sawteeth 165b that stops the first sawteeth 164 is released, the holder 161 moves outward because the elastic restoring force of the first elastic members k1 and k2 is outward applied to the holder 161.

When the holder 161 moves outward by the elastic restoring force of the first elastic members k1 and k2, the first rack gear 163a performs an outward linear movement. Thereafter, the first pinion gear 173a, the driven gear 173c and the second pinion gear 173b rotate. When the second pinion gear 173b rotates, the second rack gear 163b performs an outward linear movement. Finally, the holder 162 moves outward.

Accordingly, as the pair of holders 161 and 162 is outward widened at the same time, the holding of the communication terminal 10 is released.

When the press action of the release button 167 is stopped in the state in which the holding of the communication terminal 10 has been released, the release button 167 returns to the front by the restoring force of the third elastic member 168, the first incline 165c climbs down the second incline 167a, and one end of the stopper 165 descends again. At the same time, the other end of the stopper 165 ascends. Accordingly, the second sawteeth 165b is engaged with the first sawteeth 164, thereby stopping the first rack gear 163a.

When the first rack gear 163a is stopped, the moving of the pair of holders 161 and 162 is stopped.

An operation for closely attaching the communication terminal 10 to the front surface of the rotating unit 140 along the nonslip member R1 if the thickness of the communication terminal 10 has been changed is described below.

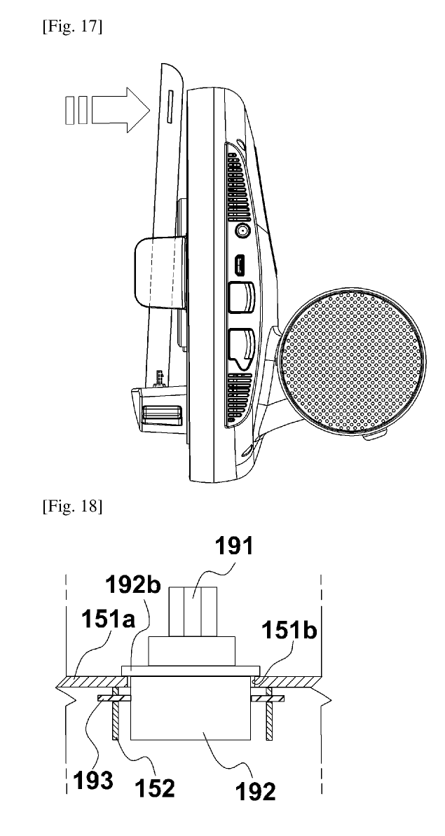

As shown in FIG. 16, if the communication terminal 10 does not come into contact with the nonslip member R1 because it has a small thickness, when the upper side of the communication terminal 10 is pushed backward, the charging terminal 191 rotates backward using the terminal rotation shaft 193 as an axis, and thus the communication terminal 10 is closely attached to the nonslip member R1 (refer to FIG. 17).

An operation for rotating the communication terminal 10 in a horizontal direction in order to view a movie, navigation or a moving image through the Internet in the state in which the communication terminal 10 has been initially located in a vertical direction as in FIG. 1 is described below.

When a user rotates the rotating unit 140 forward up to a critical angle by applying an initial force to the communication terminal 10 in order to rotate the rotating unit 140 in the horizontal direction, the rotational part 132 automatically rotates by the action of the internal cam at the critical angle, and thus the rotating unit 140 is further rotated forward.

When the rotating unit 140 continues to rotate counterclockwise and the communication terminal 10 is rotated 90° and placed in the horizontal direction (refer to FIG. 14), the stop projection 142 is stopped at one end of the guide rail 112 and thus the rotation of the rotating unit 140 is stopped.

Furthermore, as shown in FIG. 14, an operation for returning the communication terminal 10 placed in the horizontal direction to the vertical direction again is opposite the above operation.

When a user rotates the rotating unit 140 backward up to a critical angle by applying an initial force to the communication terminal 10, the rotational part 132 automatically rotates by the action of the internal cam at the critical angle and thus the rotating unit 140 further rotates backward. When the rotating unit 140 continues to rotate clockwise and thus the communication terminal 10 is placed in the vertical direction of 0° (refer to FIG. 1), the stop projection 142 is stopped at the other end of the guide rail 112 and thus the rotation of the rotating unit 140 is stopped.

The preferred embodiments according to the present invention have been described above. It will be apparent to those skilled in the art that the present invention may be implemented in other specific forms without departing from the object or scope of the invention in addition to the aforementioned embodiments.

Accordingly, the aforementioned embodiments should not be construed as being restrictive, but should be construed as being illustrative and therefore the present invention is not limited to the above description and may be modified within the scope of the appended claims and equivalents thereof.

1. A multi-functional stand for a communication terminal, comprising:
a front case (110);
a rear case (120) coupled to the front case (110);
a swing hinge (130) comprising a fixing part (131) and a rotational part (132) rotating forward or backward at an angle set in the fixing part (131), wherein the fixing part (131) is fixed to the front case (110);
a rotating unit (140) fixed to the rotational part (132) of the swing hinge (130) and rotating in response to the rotation of the rotational part (132);
a support (151) protruded on a lower side of the front surface (140a) of the rotating unit (140) and rotated along with the rotating unit (140), wherein the support supports a communication terminal (10);
a pair of holders (161 and 162) upward spaced apart the support (151) and provided in a front surface (140a) of the rotating unit (140), wherein the pair of holders (161 and 162) rotates along with the rotating unit (140) and holds the communication terminal (10) supported by the support (151);
a speaker box (198) coupled to a rear surface of the rear case (120), supporting the front case (110) and the rear case (120) so that an object on which the stand is to be disposed is upright, and outputting an audio signal output by the communication terminal (10),
wherein the pair of holders (161 and 162) moves inward or outward along a width (w1) of the communication terminal (10) and holds the communication terminal (10) by adjusting a distance between the pair of holders (161 and 162).

2. The multi-functional stand of claim 1, wherein:
the rotating unit (140) comprises a rotating unit body (140′) and a rotating unit cover 140″ covering the rotating unit body (140′),
a pair of openings (143) is formed to penetrate the rotating unit cover (140″) on left and right sides,
a guide member (171) is disposed within the rotating unit (140), and an upper guide face (171a) and a lower guide face (171a′) for guiding the pair of holders (161 and 162) so that the pair of holders (161 and 162) gathers inward or widens outward are formed in the guide member (171);
the holders (161 and 162) comprise holder bodies (161a and 162a) and handle parts (161b and 162b) which are curved from the holder bodies (161a and 162a), which are exposed through the openings (143) and which apply an external force when a user holds the handle parts (161b and 162b),
a pair of slide surfaces (161a′ and 161a″) and a pair of slide surfaces (162a′ and 162a″) are curved toward the guide member (171) on upper and lower sides of the holder bodies (161a and 162a) so that the holders (161 and 162) perform a linear movement while being guided by the upper guide face (171a) and the lower guide face (171a′),
a first elastic member (k1, k2) has one end elastically supported by an elastic support unit (161c, 162c) of the holder (161, 162) and the other end elastically supported by an elastic support piece (171b, 171b′) outward protruded from the upper and lower guide face (171a, 171a′) of the guide member (171) and applies an outward elastic force to the holders (161 and 162), and
holder stop means (164, 165 and 166) are capable of moving the holders (161 and 162) inward while compressing the first elastic members (k1 and k2), but stop an outward movement of the holders (161 and 162) when an inward external force is applied to the holders (161 and 162) and stop the holders (161 and 162) at their positions when the external force applied to the holders (161 and 162) is removed.

3. The multi-functional stand of claim 2, wherein the holder stop means (164, 165 and 166) comprise:
first sawteeth (164) of a right-angled triangle pattern inward inclined from a bottom of a slide surface (161a″) of one holder 161 of the pair of holders (161 and 162);
a stopper 165 disposed in the guide member (171) so that the stopper performs a lever action using a shaft pin (165a) as an axis, wherein second sawteeth (165b) engaged with the first sawteeth (164) are formed on the other side of the stopper (165) and the stopper (165) stops the first sawteeth (164) so that the first sawteeth (164) is capable of moving inward, but do not move outward; and
a second elastic member (166) having a bottom elastically supported by an elastic support (166a) formed in the rotating unit cover (140″), having a top elastically supported by the other side of the stopper (165), and applying an elastic force to the other side of the stopper (165).

4. The multi-functional stand of claim 3, further comprising:
a release button (167) comprising a first incline (165c) formed on one side of the stopper (165) and a second incline (167a) inclined at a tilt angle corresponding to the first incline (165c) so that the second incline comes into surface contact with the first incline (165c), wherein when a user presses the release button (167) in order to move the holder (161) outward by an elastic restoring force of the first elastic members (k1 and k2), the release button (167) pushes one side of the stopper (165) upward and simultaneously drops the other side of the stopper (165) downward by a lever action, thereby releasing locking between the second sawteeth (165b) and the first sawteeth (164); and
a third elastic member (168) having one end elastically supported by the release button (167) and the other end elastically supported by the guide member (171) so that the release button (167) is capable of returning to its position after the release button (167) is pressed.

5. The multi-functional stand of claim 3, further comprising interlocking means (163a, 163b, 173a, 173b and 173c) for moving the other holder (162) in an identical inward or outward direction while operating in conjunction with one holder (161) of the pair of holders (161 and 162) so that the pair of holders gathers or widens by simultaneously driving the pair of holders when the one holder (161) moves inward or outward.

6. The multi-functional stand of claim 5, wherein the interlocking means (163a, 163b, 173a, 173b and 173c) comprise:
first and second rack gears (163a and 163b) stepwise formed from the slide surfaces (161a″ and 162a′) in which the first sawteeth (164) of the holders (161 and 162) have been formed to the back and formed toward the slide surfaces (161a′ and 162a″) facing the first and the second rack gears (163a and 163b); and
a plurality of gears (173a, 173b and 173c) engaged with the first rack gear (163a) formed in one holder (161) and the second rack gear (163b) formed in the other holder (162), wherein when the first rack gear (163a) moves inward or outward, the plurality of gears moves the other holder (162) in the same direction as the first rack gear (163a) so that the pair of holders (161 and 162) gathers or widens at the same time.

7. The multi-functional stand of claim 1, wherein a charging terminal (191) for supplying a charging current to the communication terminal (10) held in the support (151) is protruded and provided in the support (151).

8. The multi-functional stand of claim 7, further comprising:
a locking hole (151b) formed at a center of a top surface (151a) of the support (151);
a pair of bosses (152) of a plate form formed within the support (151) to face the support;
a terminal housing (192) in which a hollow part (192a) has been formed to insert the charging terminal (191) into the hollow part (192a) and a locking piece (192b) locked and fixed to the locking hole (151b) of the support (151) has been formed; and
a terminal rotation shaft (193) laterally protruded from an outer circumferential surface of the terminal housing (192) and rotatably provided in the pair of bosses (152) in order to rotatably move the charging terminal (191) inserted into the terminal housing (192) forward or backward.

9. The multi-functional stand of claim 1, wherein:
a mounting hole (121) is formed in the rear surface of the rear case (120) and a plurality of locking hooks (122) is formed in an inner circumferential surface of the mounting hole (121) at equal intervals, and
the multi-functional stand further comprises a joint (180) in which locking stops (181) locked and fixed to the locking hooks (122) have been outward protruded in a radial direction in order to connect the multi-functional stand (100) for a communication terminal to an external instrument.

10. The multi-functional stand of claim 1, wherein:
a shaft hole (111) is backward inserted at a center of the front case (110), a shaft projection (141) is backward protruded and formed in the rear surface (140b) of the rotating unit (140) in such a way as to be rotatably inserted into the shaft hole (111), and the rotating unit (140) has a disk form formed concentrically with the shaft projection (141), and
a bottom part (110a) in which the rotating unit (140) of the disk form is seated and rotated and a circumference part (110b) formed concentrically with the shaft hole 111 are formed in the front case (110),
the multi-functional stand further comprises:
guide rails (112) spaced apart from the shaft hole (111) and inserted into the bottom part (110a) of the front case (110) in an arc form concentric with the shaft hole (111); and
a stop projection (142) which is backward protruded from the rear surface (140)b of the rotating unit (140) in such a way as to be inserted into the guide rail (112) and to rotate along the guide rail (112) and which prevents the rotating unit (140) from rotating at a set angle or more when the communication terminal (10) rotates from a vertical direction to a horizontal direction or rotates backward.
